(19) United States
(12) Patent Application Publication
(10) Pub. No.: US 2009/0107319 A1
(43) Pub. Date: Apr. 30, 2009

(54) CYMBAL WITH LOW FUNDAMENTAL FREQUENCY

(76) Inventor: John Stannard, Clearwater, FL (US)

Correspondence Address: DENNIS G. LAPOINTE;LAPOINTE LAW GROUP, PL, PO BOX 1294, TARPON SPRINGS, FL, 34688-1294, US

(21) Appl. No.: 12/250,777

(22) Filed: Oct. 14, 2008

Related U.S. Application Data
(60) Provisional application No. 60/983,360, filed on Oct. 29, 2007.

(51) Int. Cl. G10D 13/06

(52) U.S. Cl. 84/402

(57) ABSTRACT

A cymbal where the lowest frequency mode of vibration in the cymbal is less than 20 cycles per second, and where the lowest mode is of a great enough amplitude to be capable of producing a prominent vibrato effect and a prominent phase shifting effect when said cymbal is struck, the cymbal being made by hammering a concave underside of a pre-formed cymbal in a manner which forms dents in a surface of said cymbal.

### RELATED APPLICATION

This application claims the benefit of U.S. Provisional Patent Application Ser. No. 60/983,360 filed Oct. 29, 2007.

### FIELD OF THE INVENTION

This invention relates to percussion instruments, in particular cymbals with low fundamental frequencies.

1. Background of the Invention

By way of background to further understand the invention described hereinafter, the following definitions are provided:
Phase Shifting: A term commonly used in modern music recording whereby the overtone structure of a sound such as a musical instrument is modulated in a manner which periodically cancels frequencies in a cascading and repeating pattern. Examples are rotating speakers such as the “Leslie” electronic digital phase shift equipment and “flanging” signal processing equipment. A similar effect can be achieved by suspending an instrument such as a gong, and striking the gong while it is rotating.
Overtones: Overtones can be heard as simpler or individual tones or frequencies, which when combined make up the whole of a musical sound. The sum of simple sounds such as sine waves, rising and falling in amplitude and frequency can produce a complex sound. In percussion instruments, there is a complex matrix of overtones comprising the whole.
Bronze: As defined herein shall comprise any metal in which copper is alloyed with other elements to alter its properties. Such alloys include but are not limited to: phosphor/tin bronzes, high tin bronzes known as “bell” bronze, nickel bronze, aluminum bronze, titanium bronze, beryllium copper, nickel silver (a copper/zinc/nickel alloy), brass (brass is sometimes referred to as a type of bronze, and it shall be included in the bronze class herein) and combinations of these bronze alloys.
Hum note or Fundamental Tone: In percussion instruments, such as large bells, cymbals, and gongs, as well as hybrid instruments, there exists a low frequency sound which is, depending on the instrument, loud or soft in amplitude. In cymbals, this note is lower in frequency than the accompanying overtones. Instruments with a low frequency hum note or fundamental tone can produce a greater complexity of high frequency overtones. For example, a small, rigid bell with a fundamental tone of 500 cycles per second will have a small number of audible overtones which ring at increasingly high frequencies. A large cymbal or gong, formed in a flexible shape, with a fundamental or hum note in the 50 cycle range will produce an extremely complex series of overtones.

2. Prior Art

Cymbals in prior art have involved designs involving dome-shaped metal pieces of various shapes and configurations. Dome shaped contours and designs in prior art cymbals have contributed to a quality of structural integrity which adds to the cymbals strength and rigidity. While a relatively low frequency fundamental can sometimes be heard in prior art cymbals, the low frequency was not capable of anticipating the profound vibrato and oscillating phase shift effects found in this invention. Even as modern cymbals are offered in thinner designs, the trend toward utilization of greater structural integrity has continued to lead toward more rigid cymbals and hence, higher frequency fundamental tones. Even hand hammered cymbals have a uniform tension and demonstrate the qualities of integrity and rigidity expected in a dome-shaped design. The HH series hand hammered cymbals made by the Sabian company present such an example of a hand hammered cymbal line which features much of the structural integrity of machine made cymbals.

High end cymbals such as the K series line of cymbals by the Zildjian company, made using a randomized machine hammering process also have the basically rigid feel expected from a dome-shape when the cymbal is attempted to be flexed by hand.

While progressing toward the achievement of increased structural integrity in both machine and hand hammered cymbals, the state of the art has effectively been teaching away from utilizing hammering to achieve the reduced structural integrity found in this invention. This invention offers a way to achieve the novel effect of vibrato and phase shifting in a cymbal of apparent dome-shape through utilization of a unique process during the forming stage of the invention.

### SUMMARY OF THE INVENTION

This invention features a cymbal which, when struck emits a prominent vibrato effect, often with an accompanying phase shift effect. One noticeable characteristic of the invention is the feel it has when held in the hand or flexed at the edges. It offers little resistance to deflection and none of the qualities expected in a precise dome. When this invention is placed on a flat surface it can in many cases appear to be a conventional cymbal with an evenly formed dome-shape.

The round edge can, if desired, be constructed to lay perfectly along the surface of the table much in the way a conventional cymbal would. When downward force against the convex arc of the dome is applied to the invention while sitting on such a flat surface, such as a table or surface plate, the invention will resist flexing in much the same way as a conventional cymbal. When the invention is picked up by hand off said surface however, a novel feature becomes apparent. The invention seems to lack structural integrity, easily moving in seeming random directions that cause the lowest of its modes of vibrations to vibrate at a very low frequency with a considerable amplitude, the vibration being capable in many cases of modulating nearly the entire spectrum of overtones of the cymbal, producing a vibrato or a phase shifting effect, or both.

Some embodiments are so easily deflectable that when the cymbal is mounted upside down (concave side up) it will produce a much faster vibrato, owing to the restricting effect of gravity on the amplitude of the fundamental frequency.

### Low Frequency Fundamentals in Heavier Gauge Cymbals

It has been generally assumed in prior art that for a cymbal to respond with low frequency fundamentals, it must be of a thin gauge. An unexpected result of this invention can be seen when applied to thicker cymbals. When the techniques described herein are applied to thicker cymbals, low frequency fundamentals can be produced with considerably high amplitudes capable of producing considerable phase shifting effects.

### Low Frequency Fundamentals in Smaller Diameter Cymbals

This invention can produce surprisingly low fundamentals in relatively small diameter cymbals. For instance, some cymbals of 16 inches (about 40.6 cm) or less can produce subsonic fundamentals of considerably high amplitude capable of producing considerable phase shifting effects.

### Low Frequency Fundamentals in Deeply Hammered Cymbals

In conventional cymbals, deep hammer dents tend to raise the fundamental frequency of the cymbal. This invention can produce surprisingly low fundamentals of considerable amplitude capable of producing considerable phase shifting effects in relatively deeply hammered cymbals.

Such effects, especially the oscillating deep phase shift effects, could never have been anticipated by prior art.

Another novel effect can be achieved by utilizing this invention in hi-hat style cymbal pairs. One or both of the cymbals can feature the vibrato/phasing effect of the invention and be controlled by the opening and closing of the hi-hat.

### BRIEF DESCRIPTION OF THE DRAWING

FIG. 1 is a conceptual depiction of one example of how to make the present invention using a manual hammering process for making the invention.

### DETAILED DESCRIPTION OF THE INVENTION

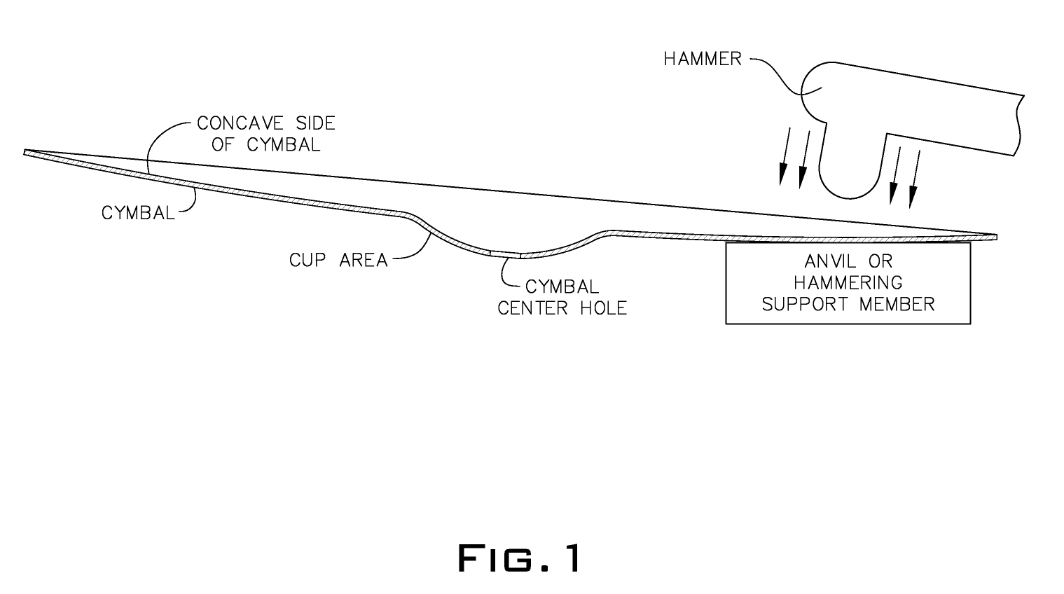

To make this invention, the structure of the cymbal must be altered in a way which reduces the inherent stiffness of the dome-shape of the cymbal. As generally depicted in FIG. 1, one example of how to make the present invention is by continuingly or significantly hammering the concave underside of the cymbal (after the main shape of tie cymbal has been formed) in a manner which forms dents in the surface of the cymbal. The cymbal can be made by continuingly hammering the concave underside of a pre-formed cymbal in a manner which forms dents in a surface of the cymbal until a structural integrity of the cymbal is reduced to a point where a fundamental frequency vibration causes a considerable vibrato and/or phase shifting effect. Such hammering requires a backing surface on which the cymbal will be supported during hammering. This backing surface can be of a hard material such as steel, or a softer material such as hard wood. The backing “block” should be of sufficient strength and mass to support the cymbal firmly and allow most of the energy of the hammer blow to transfer into forming the cymbal.

The dents can be very small, even difficult to see. When a sufficient number of the dents occurs, the structural integrity of the cymbal can be reduced to the point of creating the novel effect found in the invention.

The number of dents, and the depth and shape of dents as well as the pattern of dents in the surface all affect the overall sound of the instrument in extremely complex ways, as well as the frequency and amplitude of resultant vibrato and phase shifting effect.

While prior art cymbals had been hammered on the concave (underside), the hammering never produced the profound vibrato seen in this invention. No profound phase shifting effects have been achieved in prior art cymbals. While hammering is one preferred method of achieving this effect, other forming methods could be used.

### Nickel-Iron Grain Refining Agents

Since this invention lacks some of the inherent rigidity found in conventional cymbals, it could be subject to accidental deformation during transport and use. What is needed then, is a superior bronze alloy, which offers added strength and resistance to permanent deformation. While ductility is necessary to form the shapes in this invention, the final product must be exceedingly strong and resilient to withstand consumer use. It must hence resist deformation during use while being quite flexible. In many alloys, the metal is quite ductile (easily deformed without cracking or failure) when in the soft or partially softened state. These softer states of metal, while quite ductile, are not as strong as the hardened levels of temper in any given alloy. Temper ratings of certain alloys, especially those which are strengthened through cold work methods such as rolling, hammering or other methods which can reduce the thickness of said metal and reduce grain size and elongate the grain structure of the alloy, are rated by the percent of elongation remaining in the alloy before the metal will fail in tension.

Phosphor bronze is hardened and strengthened by cold work. Phosphor bronze alloys are typically composed of copper, tin and a small amount of phosphorous. A typical phosphor bronze, when hardened to a strength rating of extra spring temper, can only be elongated by an additional 2% before failing and breaking or cracking in tension. The addition of small amounts of iron and nickel can refine and reduce grain size and hence, increase strength. Through the addition of said iron and nickel, ideally in ranges of between 0.05 to 0.20% each, can increase strength considerably. By utilizing these grain refiners, a temper with more elongation remaining in the alloy can be used. The cymbal is preferably made in a process where the addition of small amounts of iron and nickel is used to refine and reduce alloy grain size and hence increase strength, said alloy composition being in the range of between 0.05% to 0.50% each of nickel and iron, 0.005% to 0.7% phosphorous, 6% to 16% tin, less than 1% trace elements, and the remainder copper.

A temper rating of extra hard in such an alloy will possess strength equal to extra spring in a typical bronze alloy. This extra hard temper can be elongated considerably more than extra spring temper hence allowing the deformation needed to easily form this invention. In short, a softer and more ductile temper of grain refined bronze can be stronger than a hard, more brittle temper of traditional bronze. While nickel iron grain refiners are known to increase low tin bronze strength, they are not known to increase sound quality. Low tin bronze alloys are thought to be high pitched, and of narrow range compared to equal high tin alloys in sound quality.

The inventor has found that by using nickel iron grain refiners in low tin, more affordable and workable alloys, a percussion or cymbal maker can increase taper, use of heat zones, depth and greater variations of hammering and other processes which create a structurally more complex instrument to realize a product of superior complexity of overtone structure, higher strength and a product which lends itself to greater affordability of quality control. Such processes such as greatly increased tapering would weaken common alloys but the added strength provided by nickel iron grain refiners allows the use of these special processes and features.

Many bronze instruments shared many vibrational characteristics with cymbals. Advertising copy from the two largest cymbal manufacturers teaches away from the use of low tin alloys for high quality percussion instruments by mentioning that their own product lines made of low tin alloys are of affordable, mass produced and identical quality when compared to their high tin alloy products. The Web site related to Sabian.com advertising refers to low tin alloy called B8 phrases point to an image of affordability: “rapid tech virtual cloning”; limited range of overtone structure is advertised: “focused sound”; and “lowest possible prices” all teach away from low tin alloys for use in quality cymbals and percussion. The Zildjian company (the largest cymbal maker) advertises “ultra modern crafting techniques”, “higher pitch”, “more focused overtones”, and “identical discs” for their low tin products. Such phrases teach away from very high quality to cymbal and percussion consumers, who regard hand crafting and a wider range of overtones desirable. See http://www.zildjian.com/en-US/products. Conversely the same companies promote their high tin products as works of art with centuries old secret processes which yield high quality, all of which begins with their 20% tin alloy. The use of nickel-iron grain refiners in this invention offers a method to create new cymbal embodiments of high quality and novel sound while possessing the superior flexural strength needed for this invention.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

What is claimed is:

1. A cymbal, wherein the lowest frequency mode of vibration in said cymbal is less than 20 cycles per second, and wherein said lowest mode is of a great enough amplitude to be capable of producing a prominent vibrato effect and a prominent phase shifting effect when said cymbal is struck.

2. A cymbal according to claim 1, wherein the lowest frequency mode of vibration in said cymbal is less than 15 cycles per second, and whereby said lowest mode is of a great enough amplitude to be capable of producing a prominent vibrato effect and a prominent phase shifting effect when said cymbal is struck.

3. A cymbal according to claim 1, wherein the lowest frequency mode of vibration in said cymbal is less than 10 cycles per second, and wherein said lowest mode is of a great enough amplitude to be capable of producing a prominent vibrato effect and a prominent phase shifting effect when said cymbal is struck.

4. A cymbal according to claim 1, wherein the lowest frequency mode of vibration in said cymbal is less than 5 cycles per second, and wherein said lowest mode is of a great enough amplitude to be capable of producing a prominent vibrato effect and a prominent phase shifting effect when said cymbal is struck.

5. A cymbal according to claim 1, wherein the lowest frequency mode of vibration in said cymbal is less than 3 cycles per second, and wherein said lowest mode is of a great enough amplitude to be capable of producing a prominent vibrato effect and a prominent phase shifting effect when said cymbal is struck.

6. A bronze cymbal according to claim 1, wherein said cymbal is made in a process where the addition of small amounts of iron and nickel is used to refine and reduce alloy grain size and hence increase strength, said alloy composition being in the range of between 0.05% to 0.50% each of nickel and iron, 0.005% to 0.7% phosphorous, 6% to 16% tin, less than 1% trace elements, and the remainder copper.
